(19) United States
(12) Patent Application Publication
(10) Pub. No.: US 2009/0171770 A1
(43) Pub. Date: Jul. 2, 2009

(54) INTEGRATED PURCHASING SYSTEM

(76) Inventors: Carmen Blaum, Bodenheim (DE); Martina Rothley, Schwetzingen (DE)

Correspondence Address: SAP AG c/o BUCKLEY, MASCHOFF & TALWALKAR LLC, 50 LOCUST AVENUE, NEW CANAAN, CT, 06840, US

(21) Appl. No.: 11/967,516

(22) Filed: Dec. 31, 2007

(51) Int. Cl. G06Q 10/00; G06F 17/00

(52) U.S. Cl. 705/11

(57) ABSTRACT

A system for use in conjunction with an electronic purchasing guide may include definition of a purchasing objective, generation of an evaluation of the purchasing objective based on purchasing activity, identification of an employee performance indicator associated with the purchasing objective, and determination of an employee evaluation based on the employee performance indicator and the evaluation of the purchasing objective.

### FIELD

Some embodiments relate to purchasing systems. In particular, some embodiments concern an electronic purchasing guide providing integration with employee management functions.

### BACKGROUND

Purchasing is a vital function for most businesses. Due to its data-intensive nature, purchasing and the management of purchasing activities are conventionally computer-based. Modern Supplier Relationship Management (SRM) systems, for example, provide many computerized functions related to the creation, tracking and storage of purchase orders.

A newly-hired purchaser may be trained to follow established purchasing processes. These processes may be documented in disparate electronic files (e.g., documents, spreadsheets, eMails) or in a single handbook. Although preferable to disparate files, a handbook often fails to describe many potential purchasing considerations. The rate at which such a handbook may be updated also cannot typically match the rate at which purchasing processes evolve. Even if an authoritative handbook were created, prior systems would not adequately promote compliance therewith.

Conventional systems also fail to provide efficient evaluation of purchasing performance. More particularly, conventional systems may fail to provide at least for the efficient development of purchasing objectives and evaluation of those objectives with respect to purchasing activities. Furthermore, conventional systems fail to provide efficient integration between purchasing activities and performance evaluation of the associated purchaser.

Systems to improve purchasing and related activities are therefore desired.

### BRIEF DESCRIPTION OF THE DRAWINGS

FIG. 1 is a diagram of a network according to some embodiments.

FIG. 2 is a flow diagram of a process according to some embodiments.

FIG. 3 is a block diagram of a system according to some embodiments.

FIG. 4 is a view of a user interface according to some embodiments.

FIG. 5 is a view of a user interface according to some embodiments.

FIG. 6 is a view of a user interface according to some embodiments.

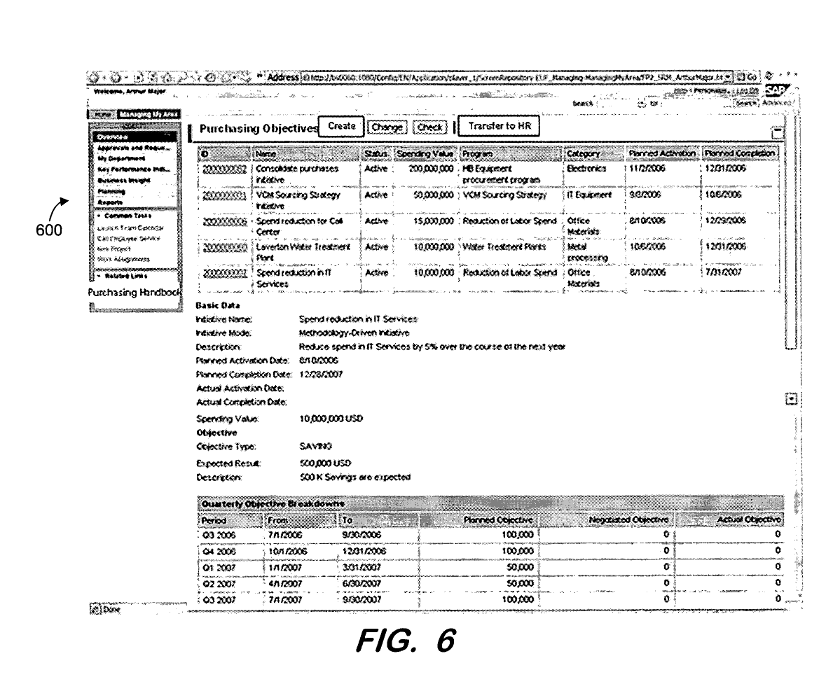

FIG. 7 is a view of a user interface according to some embodiments.

FIG. 8 is a view of a user interface according to some embodiments.

FIG. 9 is a detailed block diagram of a system according to some embodiments.

### DETAILED DESCRIPTION

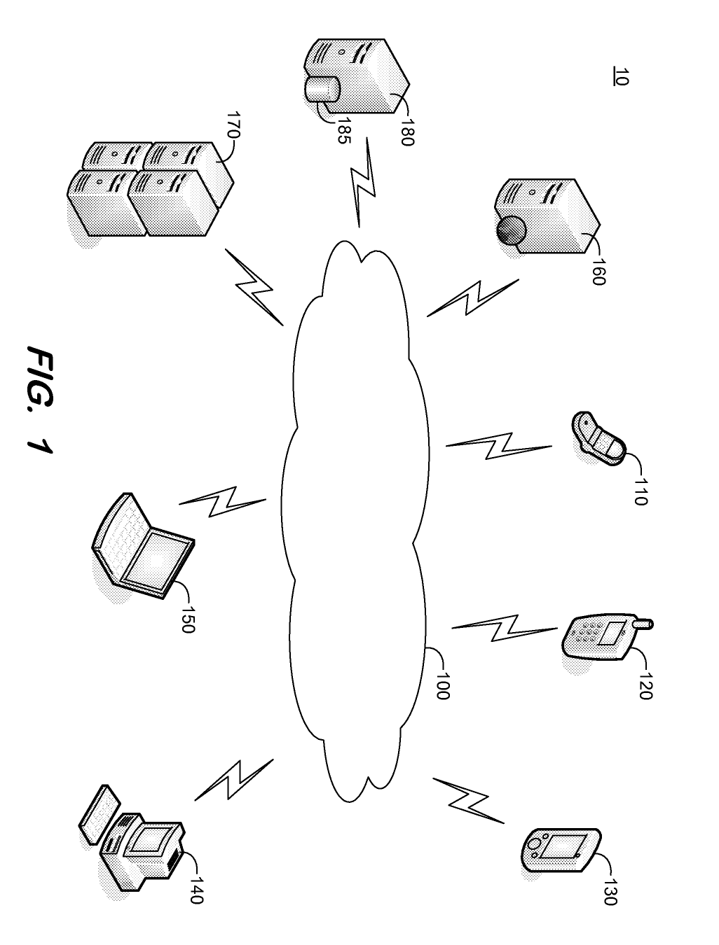

FIG. 1 is a block diagram of system 10 according to some embodiments. Each device of system 10 is capable of communication with network 100, which may comprise the Internet as well as any number of other public and/or private networks. Two or more of devices of system 10 may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

Client devices 110 through 150 may be equipped with any combination of hardware and software to enable communication with Web server 160. According to some embodiments, Web server 160 supports secure HyperText Transfer Protocol (HTTPS) communication with devices 110 through 150. Client devices 110 through 150 may request Web services from Web server 160 to access an electronic purchasing guide as described below.

Web server 160 may communicate with application servers 170 to provide requested Web services. Application servers 170, in turn, execute business applications (e.g., ABAP or Java) which interface with database management system 180 to access and manipulate business objects stored in relational database 185. Such access and manipulation may, for example, result in the creation and evaluation of purchasing objectives as described below.

Embodiments are not limited to the configuration of system 10. Some embodiments are implemented within a traditional Enterprise Resource Planning (ERP) system. Such traditional systems may employ a proprietary client application to access business functionality provided by business applications over a secure network. These business applications, as described above, interface with a database management system to access and manipulate business objects stored in a relational database.

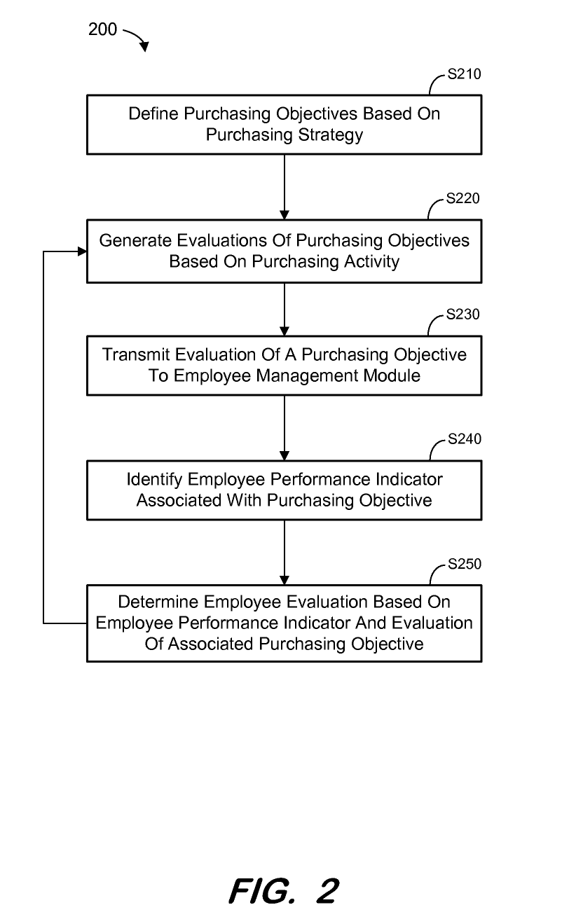

FIG. 2 is a flow diagram of process 200 according to some embodiments. Some embodiments of process 200 may be performed in conjunction with an electronic purchasing guide.

Process 200 and all other processes mentioned herein may be embodied in processor-executable program code read from one or more of a computer-readable medium, such as a floppy disk, a CD-ROM, a DVD-ROM, a Zip™ disk, a magnetic tape, and a signal encoding the process, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at S210, purchasing objectives are defined based on a purchasing strategy. A purchasing strategy may specify any techniques for use during purchasing, including but not limited to techniques associated with single sourcing, multiple sourcing, global sourcing, local sourcing, supplier classification, bottleneck suppliers, critical suppliers and non-critical suppliers. Purchasing objectives, on the other hand, may consist of one or more goals which the purchasing strategy is intended to achieve. Non-exhaustive examples of purchasing objectives include a reduced number of suppliers, an increased number of purchase order items per day, a decreased duration of purchase order processing time, a decreased duration of purchase order approval time, and a spending reduction in a particular project/department/expense category.

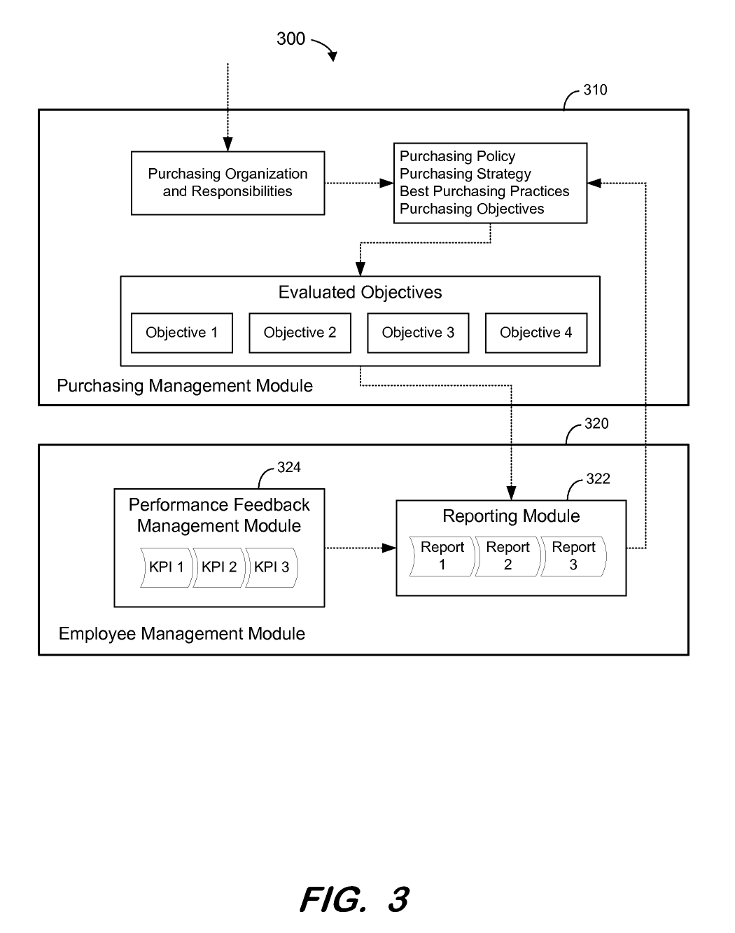

FIG. 3 is a block diagram of system 300 to perform process 200 according to some embodiments. System 300 may be embodied using any combination of hardware and software, elements of which may be located remote from one another. In some embodiments, application servers 170 implement system 300.

System 300 includes purchasing management module 310 and employee management module 320. According to some embodiments, purchasing management module 310 comprises a portion of an SRM system and employee management module 320 comprises a portion of a Human Capital Management (HCM) system. Embodiments may provide efficient integration of the illustrated portions.

FIG. 3 illustrates some processes that may occur prior to S210 in some embodiments. Specifically, purchasing management module 310 may receive data indicating a structure and responsibilities of a purchasing organization. The data may comprise business objects of an existing ERP system.

Based on and/or in conjunction with this received data, module 310 may facilitate the definition of purchasing objectives at S210. Also defined at S210 may be the purchasing strategy described above, a purchasing policy, and best purchasing practices. The definition of items at S210 may proceed manually and/or automatically based on the received data and hard-coded rules.

The purchasing policy may specify company-specific guidelines for purchasing, contract templates for various purchasing activities, etc. Best purchasing practices may consist of, for example, practices to control category spending, practices to evaluate a supplier, and practices to control quality.

Returning to process 200, S220 includes generating evaluations of the purchasing objectives based on purchasing activity. In some embodiments of S220, prior purchasing activities are analyzed to determine the extent to which the purchasing objectives are being met. The purchasing activities may be described by business objects representing purchase orders in some embodiments. Accordingly, purchasing management module 310 may be capable of accessing a database system storing such business objects. The generated evaluations may also be encapsulated and stored as business objects in some embodiments.

An evaluation of a purchasing objective is transmitted to an employee management module at S230. An employee management module according to some embodiments provides, at least, data used to conduct employee evaluations. Embodiments are not limited to an HCM system or to employee management module 320 of system 300. FIG. 3 depicts an evaluation being transmitted to reporting module 322 of module 320 at S230.

An employee performance indicator associated with the evaluated purchasing objective is identified at S240. The employee management module may include performance indicators used to evaluate the performance of one or more employees. Examples of performance indicators are illustrated as Key Performance Indicators (KPIs) within performance feedback management module 322. Performance indicators may therefore be used to provide feedback on an employee's performance.

An employee evaluation is then determined at S250 based on the identified performance indicator and the transmitted evaluation. The evaluation may indicate the extent to which an employee satisfied the purchasing objective associated with the performance indicator. S250 may be performed by module 322 in some embodiments. Flow returns to S220 from S250.

According to some embodiments, the above-mentioned data indicating a purchasing organization structure and purchasing responsibilities is automatically updated according to a predefined period. The purchasing strategy and purchasing objectives may be updated in response to the updated data.

The purchasing policy, purchasing strategy, best purchasing practices and purchasing objectives may comprise an electronic purchasing guide. The guide may be implemented within a knowledge management system providing one or more functions such as subscription, versioning, authorization, approval, and feedback. The guide may be incorporated into a new hire workflow that requires the new hire to read and acknowledge the guide prior to performing any purchasing activity.

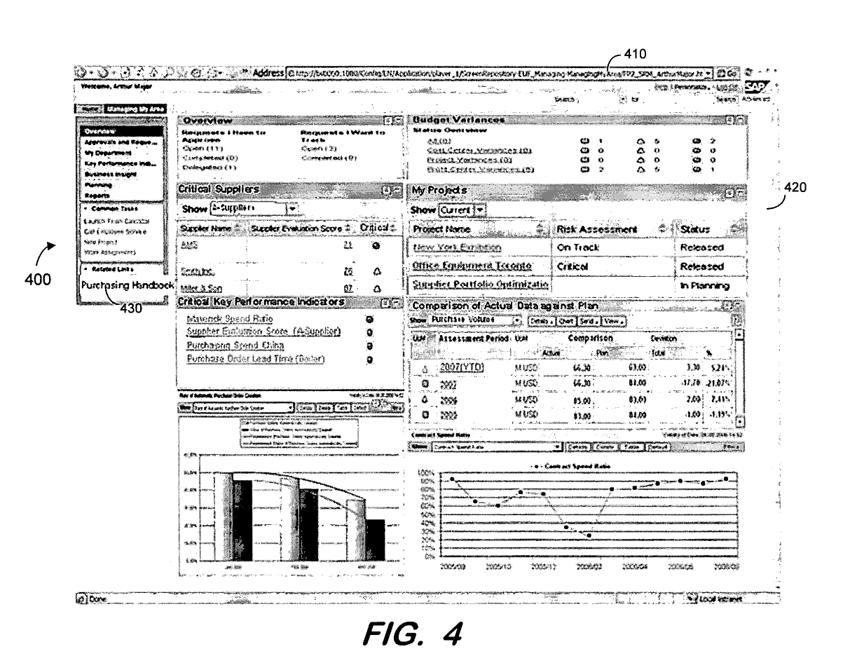

FIG. 4 is a view of interface 400 according to some embodiments. User interface 400 may comprise a Web browser window displayed by a client device executing a Web browser.

Address bar 410 includes a Uniform Resource Locator (URL) associated with a desired Web service. More particularly, the client device has requested access to the resource located at the URL. The resource may exist on a private network of which the client device is a member (in which case the client device may communicate via HTTP) or on a public network (HTTPS). After conducting appropriate authentication checks, Web page 420 is delivered to the client device for display in browser window 400.

Web page 420 may comply with any Web formats that are or become known. Web page 420 may comprise a HyperText Markup Language (HTML) page, a Java applet, a Flash control, etc. Embodiments are not, however, limited to Web-based communications.

Web page 420 includes several areas relating to various purchasing related activities. The areas may display data related to purchasing objectives and key performance indicators. Web page 420 may therefore provide historical and/or current information to determined compliance with such objectives and key performance indicators. The displayed data may be retrieved from business objects stored within a database as described above.

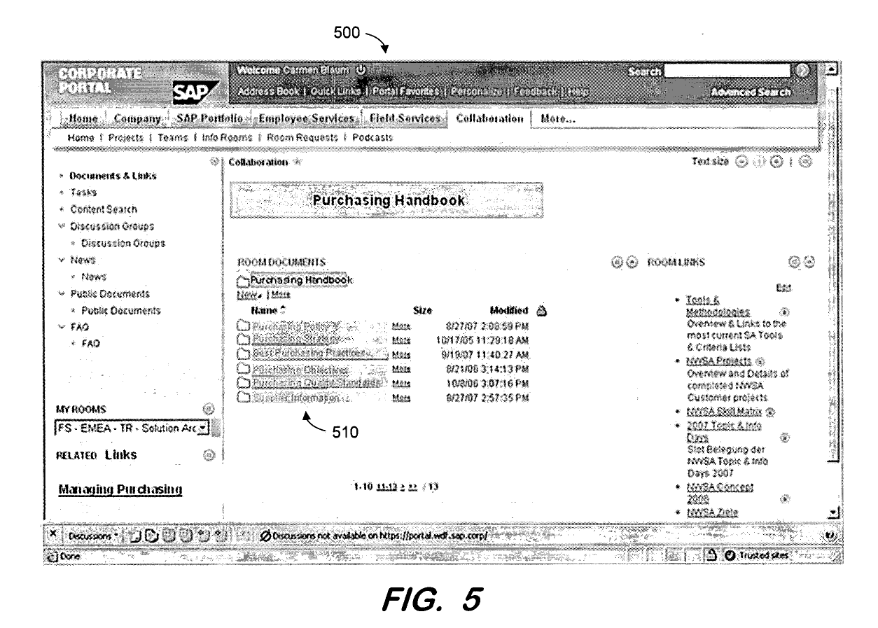

Upon selection of link 430, a user may be presented with interface 500 of FIG. 5. Interface 500 may also comprise a Web page and may provide a home page view of an electronic purchasing guide according to some embodiments. Interface 500 provides links 510 to a purchasing policy, purchasing strategy, purchasing objectives, and other desired information as described above. Interface 500 may therefore allow efficient access to a purchasing guide. Such a purchasing guide may be manually and/or automatically updated based on new information and developments.

Interface 600 shows a list of purchasing objectives defined at S210 based on a purchasing strategy according to some embodiments. Each purchasing object is associated with an identifier and may be represented by a business object in a backend database. The displayed purchasing objectives may be specific to the user accessing interface 600 or to employees managed by the user.

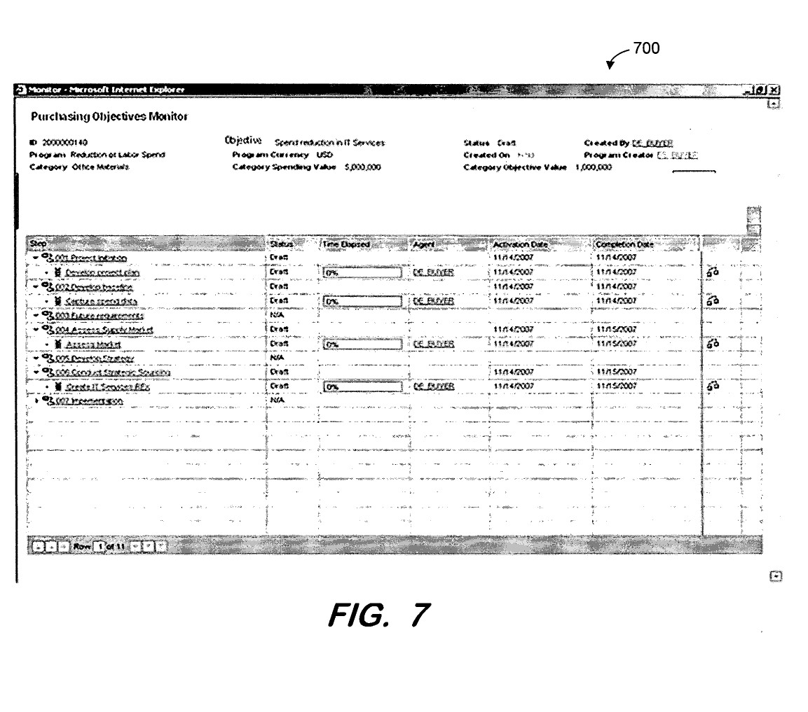

Interface 700 of FIG. 7 may be displayed upon selecting a purchasing objective identifier of interface 600. Interface 700 displays additional details of the selected purchasing objective. The detailed elements of the purchasing objective displayed in interface 700 may be defined at S210 during definition of the purchasing objective. Interface 700 allows a user to track progress toward completion of a purchasing objective.

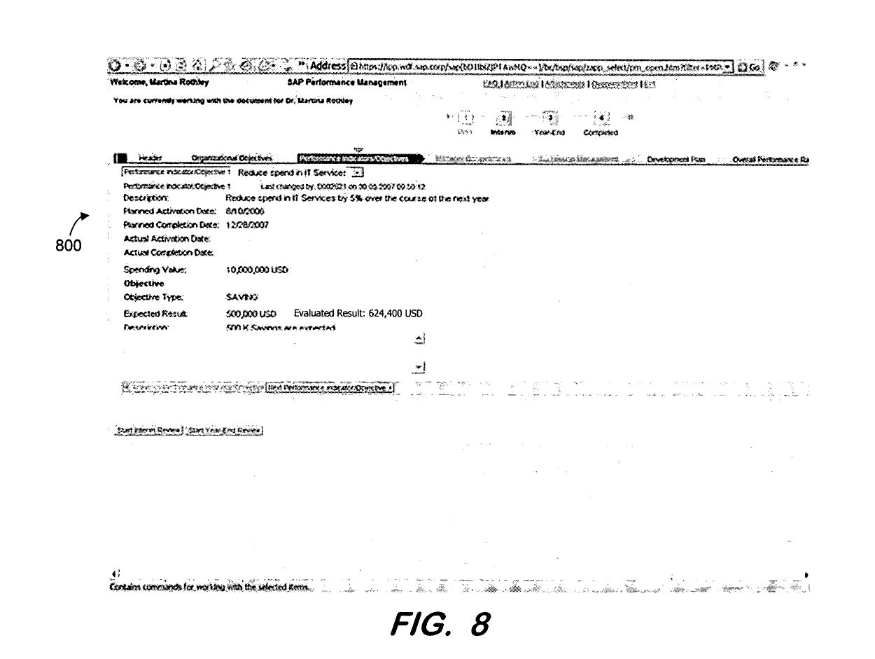

Interface 800 of an employee management module is shown in FIG. 8. User interface 800 illustrates an employee evaluation determined at S250 of process 200 according to some embodiments. The employee evaluation is based on an employee performance indicator and on the evaluation of a purchasing objective associated with the performance indicator.

Some embodiments execute rules to provide automatic outcomes (bonus, etc) based on a comparison between an expected result and an evaluated result. These outcomes may be continuously tracked and displayed to a user in an area of interface 400 or through other means.

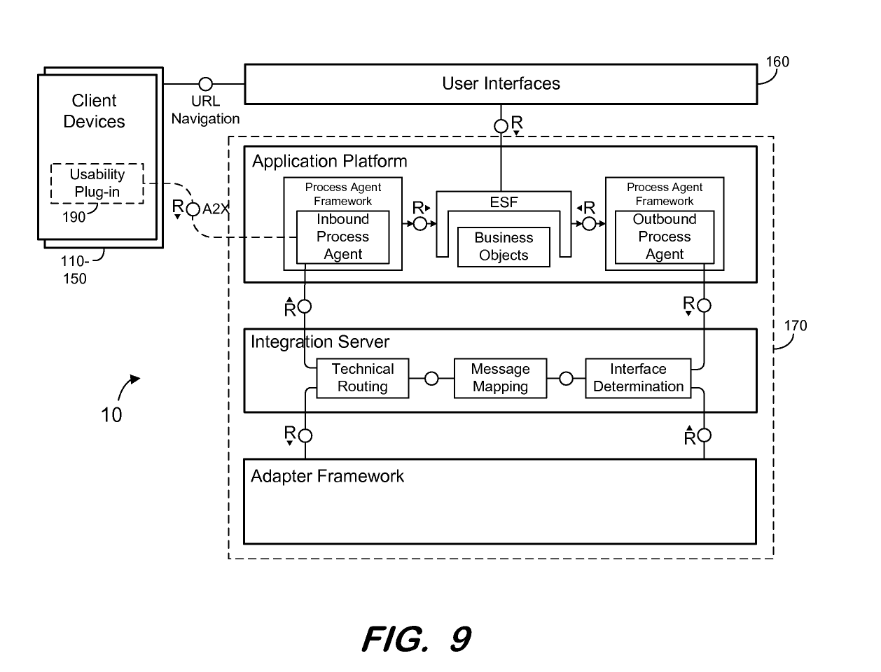

FIG. 9 is a detailed block diagram of a portion of system 10 according to some embodiments. Some embodiments may differ from that illustrated in FIG. 9. As mentioned above, some embodiments may comprise a conventional ERP system.

As described above, each of client devices 110 through 150 may support HTTP communication for URL-based navigation to user interfaces provided Web server 160. One or more of device 110 through 150 may also include usability plug-in 190 to provide an extension of base browser functionality. The extension may allow a client device to communicate directly with an application platform of application servers 170.

In this regard, application servers 170 include an application platform, an integration server, and an adapter framework. According to some embodiments, the adapter framework uses adapters to facilitate communication between a business process platform and separate systems associated with each of the adapters. The separate systems may comprise database management systems, legacy data systems, other ERP systems, or the like.

The integration server routes messages to and from appropriate interfaces of the application platform. The integration server may also provide mapping of incoming and outgoing messages according to pre-configured mappings. SAP XI ® provides an integration server suitable for use in conjunction with some embodiments.

The application platform supports process agents for implementing message interfaces (i.e., providing Web services) by communicating with an Enterprise Service Framework (ESF), such as a Service-Oriented Architecture (SOA) provided by SAP AG. The ESF provides an API for instantiating and manipulating business objects which encapsulate data and related methods of business logic that describes a business process or task. As described above, purchase orders and purchasing-related documents may be represented by business objects in some embodiments.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

The embodiments described herein are solely for the purpose of illustration. Those in the art will recognize other embodiments may be practiced with modifications and alterations limited only by the claims.

What is claimed is:

1. A method for use in conjunction with an electronic purchasing guide comprising:
defining a purchasing objective;
generating an evaluation of the purchasing objective based on purchasing activity;
identifying an employee performance indicator associated with the purchasing objective; and
determining an employee evaluation based on the employee performance indicator and the evaluation of the purchasing objective.

2. A method according to claim 1, further comprising:
transmitting the evaluation of the purchasing objective to an employee management module,
wherein the employee management module determines the employee evaluation.

3. A method according to claim 1, further comprising:
receiving data indicating a structure of a purchasing organization and purchasing responsibilities; and
defining a purchasing strategy based on the received data,
wherein the purchasing objective is defined based on the purchasing strategy.

4. A method according to claim 3, further comprising:
automatically updating the received data according to a predefined period.

5. A method according to claim 3, further comprising:
defining a respective purchasing template for each of a plurality of purchasing activities; and
defining a plurality of best purchasing practices.

6. A method according to claim 3, further comprising:
requiring a purchaser to acknowledge the electronic purchasing guide prior to conducting a purchasing activity.

7. A method according to claim 1, further comprising:
generating a current evaluation of the purchasing objective based on current purchasing activity; and
presenting the current evaluation to a purchaser.

8. A computer-readable medium storing processor-executable process steps for use in conjunction with an electronic purchasing guide, the process steps comprising:
a step to define a purchasing objective;
a step to generate an evaluation of the purchasing objective based on purchasing activity;
a step to identify an employee performance indicator associated with the purchasing objective; and
a step to determine an employee evaluation based on the employee performance indicator and the evaluation of the purchasing objective.

9. A medium according to claim 8, the process steps further comprising:
a step to transmit the evaluation of the purchasing objective to an employee management module,
wherein the employee management module determines the employee evaluation.

10. A medium according to claim 8, the process steps further comprising:
a step to receive data indicating a structure of a purchasing organization and purchasing responsibilities; and
a step to define a purchasing strategy based on the received data,
wherein the purchasing objective is defined based on the purchasing strategy.

11. A medium according to claim 10, the process steps further comprising:
a step to automatically update the received data according to a predefined period.

12. A medium according to claim 11, the process steps further comprising:
a step to define a respective purchasing template for each of a plurality of purchasing activities; and
a step to define a plurality of best purchasing practices.

13. A medium according to claim 11, the process steps further comprising:
a step to require a purchaser to acknowledge the electronic purchasing guide prior to conducting a purchasing activity.

14. A medium according to claim 8, the process steps further comprising:
a step to generate a current evaluation of the purchasing objective based on current purchasing activity; and
a step to present the current evaluation to a purchaser.

15. A system comprising:
a purchasing management module to define a purchasing objective, and to generate an evaluation of the purchasing objective based on purchasing activity; and
an employee management module to identify an employee performance indicator associated with the purchasing objective, and to determine an employee evaluation based on the employee performance indicator and the evaluation of the purchasing objective.

16. A system according to claim 15, the purchasing management module to receive data indicating a structure of a purchasing organization and purchasing responsibilities, and to define a purchasing strategy based on the received data,
wherein the purchasing objective is defined based on the purchasing strategy.

17. A system according to claim 15, the purchasing management module to automatically update the received data according to a predefined period.

18. A system according to claim 15, the purchasing management module to require a purchaser to acknowledge an electronic purchasing guide prior to conducting a purchasing activity.

19. A system according to claim 15, the purchasing management module to generate a current evaluation of the purchasing objective based on current purchasing activity, and to present the current evaluation to a purchaser.
